(19) United States
(12) Patent Application Publication
(10) Pub. No.: US 2026/0189181 A1
(43) Pub. Date: Jul. 2, 2026

(54) PHOTOVOLTAIC MODULE MOUNTING ASSEMBLY WITH A PURLIN INCLUDING SPACERS

(71) Applicant: Gamechange Solar Corp., Norwalk, CT (US)

(72) Inventors: Nathaniel Healy, Brooklyn, NY (US); Scott Van Pelt, Tarrytown, NY (US)

(73) Assignee: Gamechange Solar Corp., Norwalk, CT (US)

(21) Appl. No.: 19/003,817

(22) Filed: Dec. 27, 2024

(51) Int. Cl. H02S 20/32

(52) U.S. Cl. CPC H02S 20/32

(57) ABSTRACT

A photovoltaic module mounting assembly includes a rotatable torque tube and a purlin attached to the rotatable torque tube. The purlin includes a web extending between (i) a first sidewall with a first flange extending therefrom and (ii) a second sidewall with a second flange extending therefrom. The first and second flanges extend along a first plane and where the first and second sidewalls are substantially opposing and spaced apart to form a cavity. A first module spacer extends from the purlin above the first plane to facilitate repeatable positioning of a first photovoltaic module on the first flange. A second module spacer extends from the purlin above the first plane to facilitate repeatable positioning of the first photovoltaic module on the first flange.

### CROSS REFERENCE TO RELATED APPLICATIONS

This application claims the benefit of U.S. Provisional Patent Application Ser. No. 63/616,574 filed Dec. 30, 2023 which is hereby incorporated by reference.

### BACKGROUND OF THE INVENTION

### 1. Technical Field

This disclosure relates generally to a solar panel installation and, more particularly, to a photovoltaic module mounting assembly.

### 2. Background Information

To fasten solar panels to a mount (e.g., a single axis tracker), various systems, mounting brackets, clamps and other fasteners exist. In utility scale solar power plants not only must the system for mounting photovoltaic panels be secure and rugged, but the system must also be relatively easy and quick to install.

There is a need for an improved assembly for mounting a photovoltaic module.

### SUMMARY OF THE DISCLOSURE

According to an aspect of the present disclosure, a photovoltaic module mounting assembly includes a rotatable torque tube and a purlin attached to the rotatable torque tube. The purlin includes a web extending between (i) a first sidewall with a first flange extending therefrom and (ii) a second sidewall with a second flange extending therefrom. The first and second flanges extend along a first plane and where the first and second sidewalls are substantially opposing and spaced apart to form a cavity. A first module spacer extends from the purlin above the first plane to facilitate repeatable positioning of a first photovoltaic module on the first flange. A second module spacer extends from the purlin above the first plane to facilitate repeatable positioning of the first photovoltaic module on the first flange.

The first module spacer may be one of brazed or welded to a first interior surface of the first sidewall.

The first module spacer may be unitary with the purlin.

The first and second module spacers may be metallic.

The first module spacer may include a first segment that is attached to the first sidewall, a second segment that extends at a first oblique angle from the first segment, and a third segment that extends from the second segment at a second oblique angle, where the second and third segments are in spaced relationship with the purlin.

The first module spacer may include a first segment that is attached to the first sidewall, a second segment that extends at an acute angle from the first segment, and a third segment that extends from the second segment at a second acute angle, where the second and third segments are in spaced relationship with the purlin.

The first module spacer may include a first segment that is attached to the first sidewall and a second segment extending above the first plane.

The first module spacer may include a first segment that extends at an oblique angle from the first sidewall and a second segment substantially coaxial with the first sidewall and extends above the first plane.

The photovoltaic module mounting assembly may also include a third module spacer extending from the purlin above the first plane to facilitate positioning of a second photovoltaic module on the second flange, and a fourth module spacer extending from the purlin above the first plane to facilitate positioning of the second photovoltaic module on the second flange, where the first and second module spacers extend from the first sidewall in spaced relationship on opposite sides of the rotatable torque tube that extends orthogonally to a longitudinal axis of the purlin.

The first flange may extend orthogonally from the first sidewall.

The photovoltaic module mounting assembly may include a third module spacer attached to the first interior surface of the first sidewall and extending above the first plane, and a fourth module spacer attached to the second interior surface of the second sidewall and extending above the first plane, where the first and third module spacers are attached to the first interior surface in spaced relationship on opposite sides of the torque tube that extends orthogonally to a longitudinal axis of the purlin.

The first module spacer may extend from a first plate located between and attached to the first and second flanges.

The photovoltaic module mounting assembly may include a second plate located between and attached to the first and second flanges and including the second module spacer.

The first and second module spacers may extend from at least one of a reinforcement channel or a load distribution channel located in the cavity and that the purlin nests around.

The third and fourth module spacers extend from at least one of the reinforcement channel or the load distribution channel located in the cavity and that the purlin nests around.

The first segment may extend at the oblique angle inwardly from the first sidewall.

The first segment may extend at the oblique angle outwardly from the first sidewall.

The foregoing features and the operation of the invention will become more apparent in light of the following description and the accompanying drawings.

### BRIEF DESCRIPTION OF THE DRAWINGS

FIG. 1 is a perspective view of a photovoltaic module mounting assembly that includes a purlin;

FIG. 2 is a perspective view of first and second photovoltaic modules mounted to the purlin, which includes first and second spacer fingers;

FIG. 3 is a side view of the first and second photovoltaic modules mounted to the purlin and positioned adjacent to the first and second spacer fingers;

FIG. 4 is a perspective view of the purlin with a first photovoltaic module mounted thereon and positioned against the first spacer finger and a third spacer finger;

FIG. 5 is a perspective view of a second embodiment of a photovoltaic module mounting assembly that includes a purlin;

FIG. 6 is a perspective view of a third embodiment of a photovoltaic module mounting assembly that includes a purlin;

FIG. 7 is a perspective view of a fourth embodiment of a photovoltaic module mounting assembly that includes a purlin;

FIG. 8 is a perspective view of a fifth embodiment of a photovoltaic module mounting assembly that includes a purlin; and

FIG. 9 is a perspective view of a sixth embodiment of a photovoltaic module mounting assembly that includes a purlin.

### DETAILED DESCRIPTION

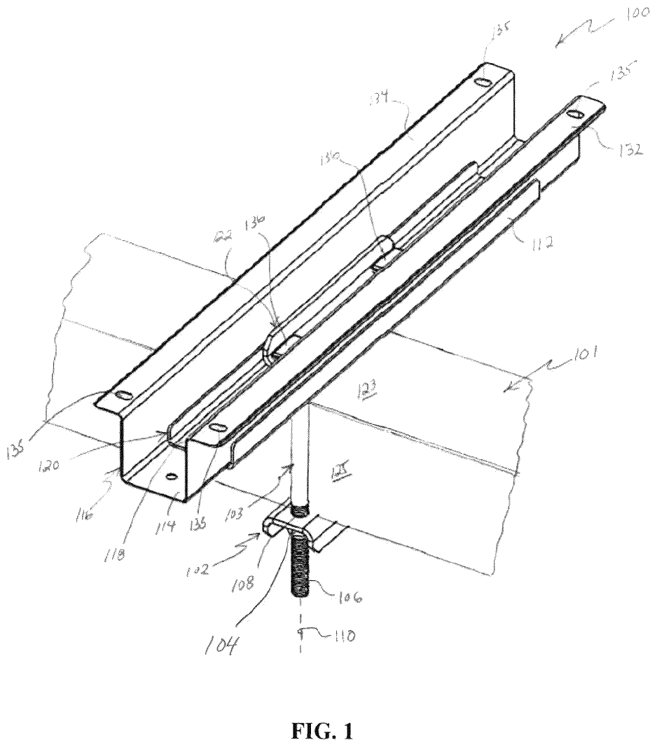

FIG. 1 is a perspective view of a photovoltaic module mounting assembly 100. The mounting assembly 100 comprises a mounting base 102 that clamps the mounting assembly 100 to a structural member 101, using for example one or more threaded fasteners 103 and one or more cooperating first attachment structure(s) 104 (e.g., a threaded nut). The threaded fasteners 103 may include a polygonal headed fastener, such as for example, a rectangular or square headed threaded bolt. The first attachment structure 104 can attach to the threaded fastener 103 via a threaded segment 106 of the threaded fastener 103, where the threaded fastener extends through one or more aperture(s) 108 in the mounting base 102.

The first attachment structure/threaded nut 104 can be selectively loosened and/or removed from the threaded segment 106, such that the mounting base 102 can be removed or slid along the structural member 101 to a desired mounting location. The mounting base 102 is configured to receive the threaded fastener 103, which extends along a fastener axis 110 through the aperture 108. In an example, the fastener axis 110 may be substantially parallel to a plane within which side surface 125 of the structural member 101 extends. The threaded nut 104 can be secured to the threaded fastener 103 within a channel formed by a web and sidewalls of the mounting base 102.

Referring still to FIG. 1, a first reinforcement channel 112 can be secured to be adjacent to a top surface 123 of the structural member 101 via the fastener 103, which extends through apertures/holes of the reinforcement channel 112. The fasteners 103 extend along the exterior sidewalls (e.g., 125) of the structural member 101 and through the apertures 108 in the mounting base 102.

The first reinforcement channel 112 is configured to nest around a base 114 of a hat-shaped channel/purlin 116. The hat-shaped channel/purlin 116 is configured to nest around a base 118 of a second reinforcement channel 120. The second reinforcement channel 120 is configured to nest around a load distributing channel 122. In an exemplary embodiment, the mounting assembly 100 comprises the mounting base 102, the first reinforcement channel 112, the hat-shaped channel/purlin 116, the second reinforcement channel 120 and the load distributing channel 122. Each component 102, 112, 116, 120 and 122 may be removable with respect to the fastener 103 extending along the fastener axis 110. The fastener 103 is received through coaxial apertures located within a mounting base 102, the first reinforcement channel 112, the hat-shaped channel/purlin 116, the second reinforcement channel 120 and the load distributing channel 122. While the illustrated exemplary embodiment includes two separate polygonal (e.g., square headed) fasteners 103, any number of fastener(s) is contemplated.

A first photovoltaic module (not shown) can be mounted to a first flange 132 of the hat-shaped channel/purlin 116. A second photovoltaic module (not shown) can be mounted to a second flange 134 of the hat-shaped channel/purlin 116. Each photovoltaic module rests on its respective flange 132, 134 and is fastened to its respective flange with a fastener (not shown), such as a nut and bolt. The fastener securing the photovoltaic module to the respective flange passes through an associated flange hole 135, and the fastener shall be discussed hereinafter.

The photovoltaic module mounting assembly 100 illustrated in FIG. 1 includes a number of components that may not be necessary in all embodiments. For example, it is contemplated that the purlin 116 may be mounted to the structural member 101 without the first reinforcement channel 112, the second reinforcement channel 120 and/or the load distributing channel 122.

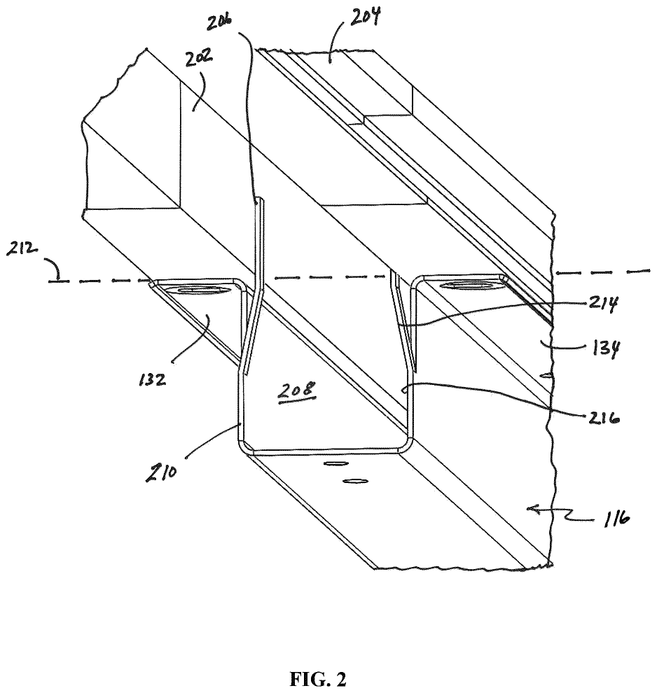

FIG. 2 is a perspective view of first and second photovoltaic modules 202, 204 mounted to the purlin 116. The purlin 116 includes a first spacer (e.g., finger) 206 attached to an interior surface 208 of the first purlin sidewall 210 and extending above a first plane 212 formed by top surfaces of the first and second flanges 132, 134. The purlin 116 also includes a second spacer 214 attached to an interior surface 216 of the second purlin sidewall 218 and extending above the first plane 212. The first and second spacers 206, 214 and the purlin 116 may be metallic. A portion of the first spacer 206 may be attached (e.g., by brazing or welding) to the interior surface 208 of the first purlin sidewall 210. Similarly, a portion of the second spacer 214 may be attached to the interior surface 216 of the second purlin sidewall 218.

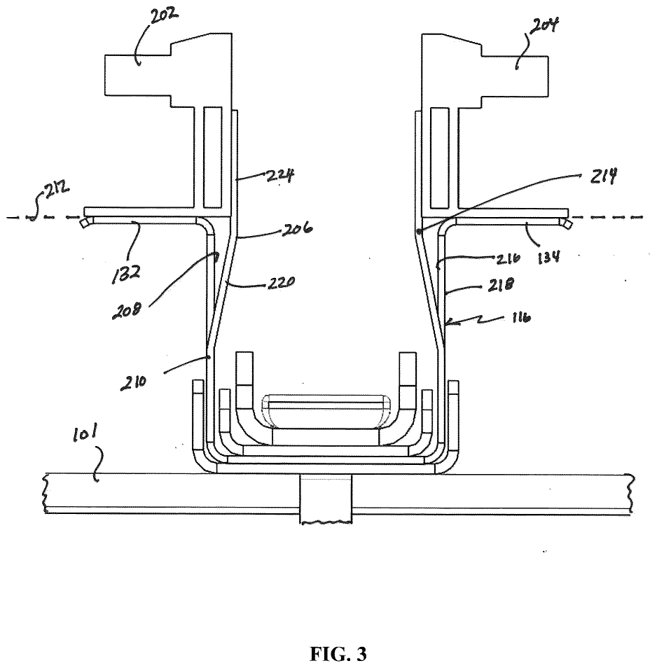

FIG. 3 is a side view of the first and second photovoltaic modules 202, 204 mounted to the purlin 116 and positioned adjacent to the first and second spacers 206, 214. In this exemplary embodiment, the first and second spacers 206, 214 include a plurality of segments. For example, the first spacer 206 comprises a first segment 220 that is attached to the interior surface 208 of the first purlin sidewall 210, a second segment 222 that extends at a first oblique angle from the first segment 220, and a third segment 224 that extends from the second segment 222 at a second oblique angle. The second and third segments 222, 224 are in spaced relationship (e.g., not directly in contact) with the purlin 216, while the first segment 220 is attached from the interior surface 208 of the first purlin sidewall 210.

In one embodiment, a second segment 222 extends at an acute angle from the first segment 220, and a third segment 224 extends from the second segment 222 at a second acute angle, where the second and third segments are in spaced relationship with the purlin. In yet another embodiment, the first spacer finger 206 comprises a plurality of segments including a first segment that is attached to the first purlin sidewall 210 and another segment that extends above the first plane 212. The second segment may be substantially coaxial with the first segment and extend above the first plane.

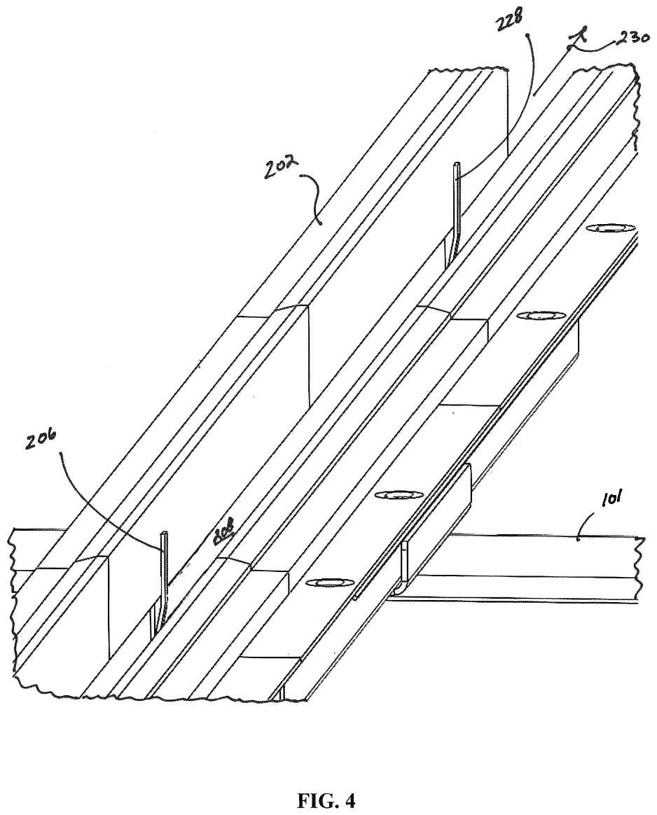

FIG. 4 is a perspective view of the purlin 116 with the first photovoltaic module 202 mounted thereon and positioned against the first spacer 206 and a third spacer 228. The first and third spacers 206, 228 are attached to the first interior surface 208 in spaced relationship on opposite sides of the structural member (e.g., a rotatable torque tube) 101 (FIG. 1), extending orthogonally to the longitudinal axis 230 of the purlin 116. The second and fourth spacers may be similarly arranged on the interior surface of the second purlin sidewall 218. The operation of the assembly shall be discussed.

Referring to FIGS. 1-4, during installation the mounting assembly 100 is slid along the torque tube 101 until the first photovoltaic panel 202 is adjacent to the first spacer 206 and the third spacer 228 (FIG. 4). The threaded fastener(s) 103 (FIG. 1) are then tightened to securely position the mounting assembly 100 on the torque tube 101. Fasteners (e.g., square headed fasteners) are then used to secure the first photovoltaic panel 202 to the first flange 132 of the purlin 116 via flange holes 135 (FIG. 1). Second photovoltaic panel 205 is then secured to the second flange 134 of the purlin 116 via the flange holes 135 in the second flange when the second photovoltaic panel 205 is positioned adjacent to the second and fourth spacers. These steps are then repeated to complete installation of the second photovoltaic panel.

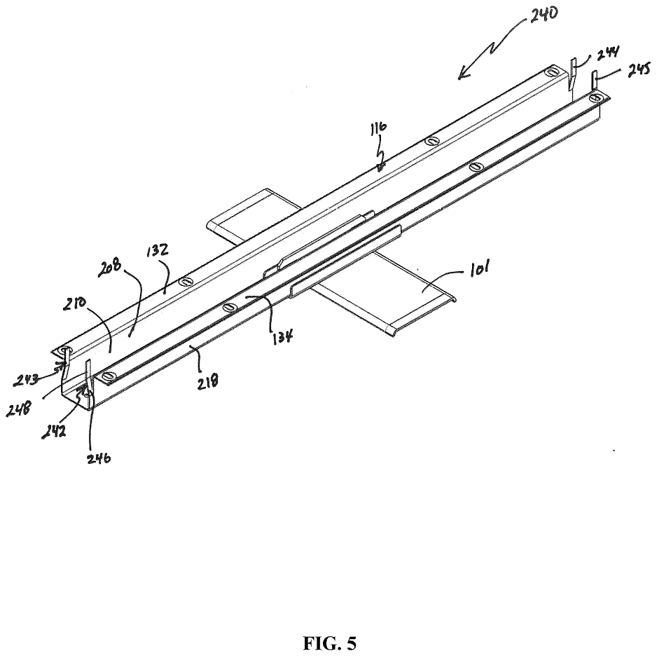

FIG. 5 is a perspective view of a second embodiment photovoltaic module mounting assembly 240. The embodiment is substantially the same as the embodiment in FIGS. 2-4 with the principal exception that spacers 242-245 are located at longitudinal ends of the purlin. In this embodiment, the spacers 242-245 each include a plurality of segments. For example, the second spacer 243 comprises a first segment 246 that extends at a first oblique from the interior surface of the second purlin sidewall 218 towards the second purlin sidewall 210, and a second segment 248 that extends at a second oblique angle from the first segment 246 and above the first and second flanges 132, 134. In this embodiment the spacers 242-245 are located at longitudinal ends of the first and second purlin sidewalls 210, 218 and unitary (e.g., formed from a single piece of material) with respect to the purlin 116.

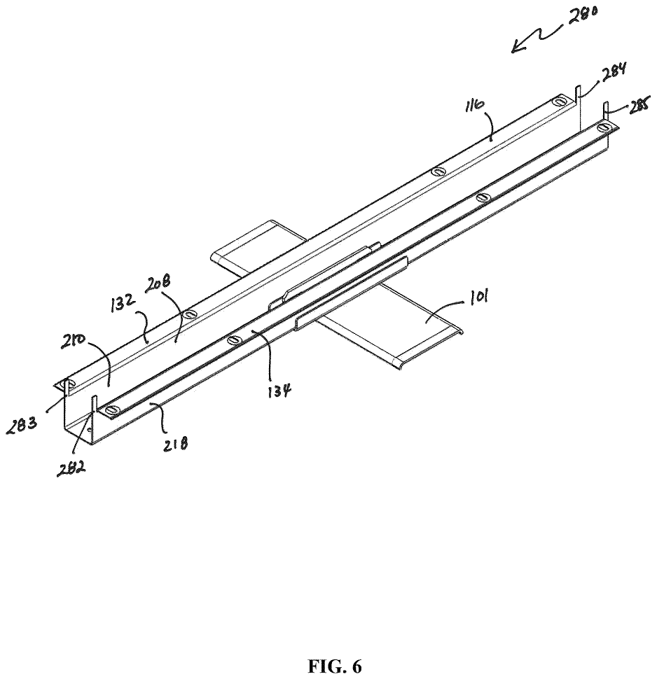

FIG. 6 is a perspective view of a third embodiment photovoltaic module mounting assembly 280. This embodiment is substantially the same as the embodiment in FIGS. 2-4 with the principal exception that spacers 282-285 are located at longitudinal ends of the purlin and flush with the interior surfaces of the first and second purlin sidewalls 210, 218. The spacers 282-285 may be unitary with the purlin 116 or attached to the purlin. The spacers 282-285 can extend linearly, non-linearly, be straight, segmented or even include a radius to extend upwardly beyond the top surfaces of the first and second flanges 132, 134 in order to provide an abutment to assist with positioning of photovoltaic panels to be mounted to the purlin. The spacers 282-285 are illustrated as straight in FIG. 6.

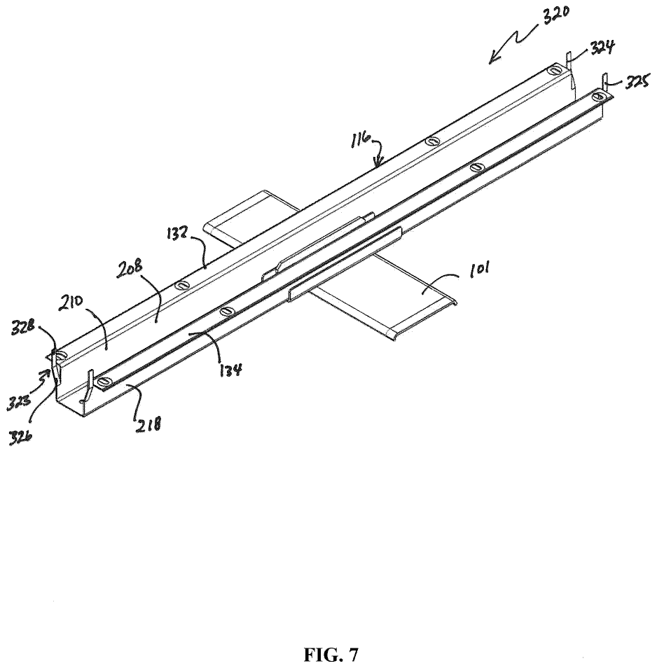

FIG. 7 is a perspective view of a fourth embodiment photovoltaic module mounting assembly 320. The embodiment is substantially the same as the embodiment in FIGS. 2-4 with the principal exception that spacers 322-325 are located at longitudinal ends of the purlin. In this embodiment, the spacers 322-325 each include a plurality of segments. For example, the second spacer 323 comprises a first segment 326 extending from and outside of the interior surface 208 of the first purlin sidewall 210, and a second segment 328 that extends at a first oblique angle from the first segment 326. In this embodiment the spacers 322-325 are located at longitudinal ends of the first and second purlin sidewalls 210, 218 and the second segments located outside of the first and second purlin sidewalls 210, 218. The spacers 322-325 can extend linearly, non-linearly, be straight, segmented as shown in FIG. 7 or even include a radius to extend upwardly beyond the top surfaces of the first and second flanges 132, 134 in order to provide an abutment to assist with positioning of photovoltaic panels to be mounted to the purlin.

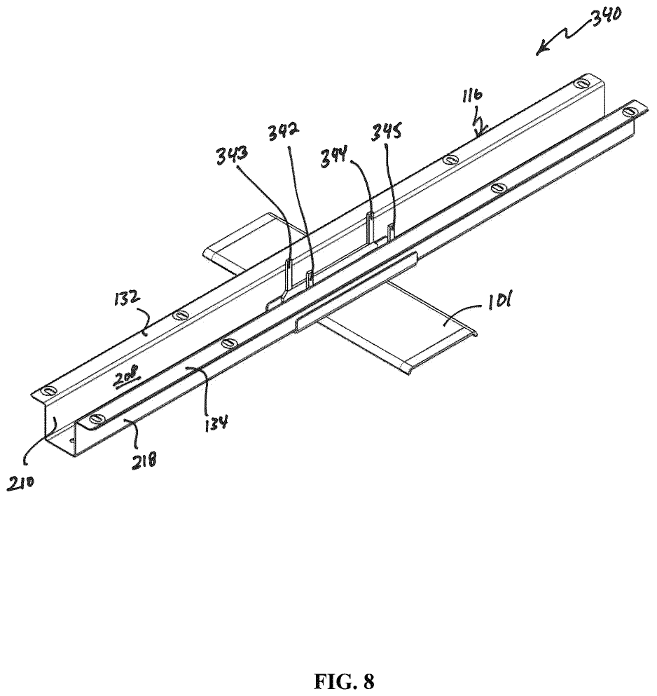

FIG. 8 is a perspective view of a fifth embodiment photovoltaic module mounting assembly 340. In this embodiment, rather than locating spacers on the purlin itself as shown in FIGS. 2-7, spacers 342-345 may be located on the second reinforcement channel 120 (FIG. 1) or the load distributing channel 122 (FIG. 1). As discussed above with respect to FIG. 1, the hat-shaped channel/purlin 116 is configured to nest around the base 118 of the second reinforcement channel 120. The second reinforcement channel 120 nests around the load distributing channel 122 (FIG. 1). In this embodiment, at least one of the second reinforcement channel 120 or the load distributing channel 122 includes the spacers 342-345 that extend upwardly beyond the top surfaces of the first and second flanges 132, 134. The spacers 342-345 can extend linearly, non-linearly, be straight, segmented or even include a radius to extend upwardly beyond the top surfaces of the first and second flanges 132, 134 in order to provide an abutment to assist with positioning of photovoltaic panels to be mounted to the associated purlin.

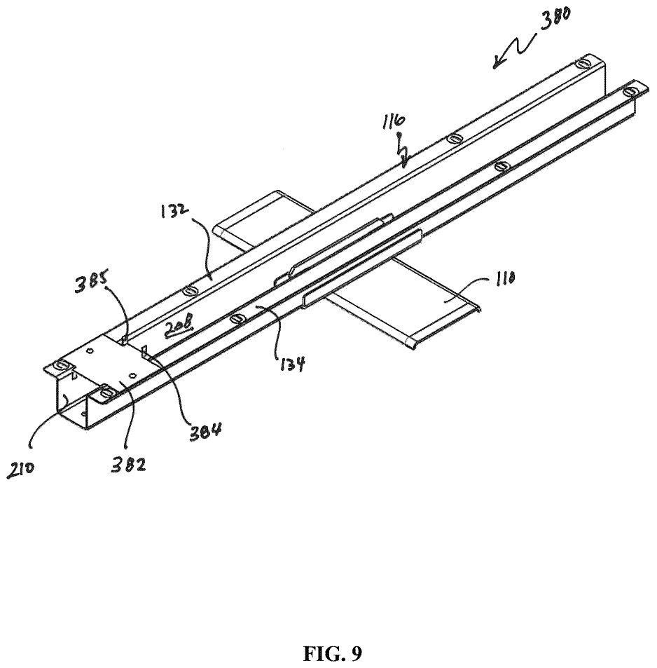

FIG. 9 is a perspective view of a sixth embodiment photovoltaic module mounting assembly 380. In this embodiment, a first plate 382 extends between and is attached to the first and second flanges 132, 134 (e.g., by rivets) towards a first longitudinal end of the purlin. A second plate may be attached at a second longitudinal end of the purlin. Each of the plates includes spacers 384-385 that extend upwardly away from the purlin in order to provide an abutment to assist with positioning of photovoltaic panels. The spacers 384-385 can extend linearly, non-linearly, be straight as shown in FIG. 9, or even include a radius to extend upwardly beyond the top surfaces of the first and second flanges 132, 134 in order to provide an abutment to assist with positioning of photovoltaic panels to be mounted to the purlin.

The spacers can be unitary with the purlin, or be a separate component that is part of the photovoltaic module mounting assembly. The exemplary embodiments illustrated herein each illustrate an example of an assembly that includes spacers to assist with the quick positioning of photovoltaic modules on the purlin during assembly rather than using a jig that the installer has to constantly handle during assembly of a row of solar panels (e.g., a utility scale single axis solar tracker).

Although the subject matter has been described in language specific to structural features or methodological acts, it is to be understood that the subject matter defined in the appended claims is not necessarily limited to the specific features and acts described above. Rather, the specific features and acts described above are disclosed as example forms of implementing at least one of the claims.

Various operations of embodiments are provided herein. The order in which some or all of the operations described should not be construed to imply that these operations are necessarily order dependent. Alternatively ordering will be appreciated having the benefit of this description. Further it will be understood that not all operations are necessarily present in each embodiment provided herein. Also it will be understood that not all operations are necessary in some embodiments.

Many modifications may be made to the current invention without departing from the scope or spirit of the claimed subject matter. Unless specified otherwise, “first,” “second,” or the like are not intended to imply a temporal aspect, a spatial aspect, an ordering etc. Rather such terms are merely used as identifiers names etc. for features, elements, items etc. for features, elements, items, etc. For example, a first location and a second location correspond to location A and location B or two different or two identical locations or the same location.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are to be construed to mean “one or more” unless specified otherwise or clear from context to be directed to a singular form. Also, at least one of A and B or the like means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alternations and modifications will occur to others skilled in the art based upon reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe the components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one or several implementations, such feature may be combined with one or more other features of the other implementations as may be desired and advantageous for any given or particular application.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A photovoltaic module mounting assembly, comprising:
a rotatable torque tube;
a purlin attached to the rotatable torque tube, the purlin comprising a web extending between (i) a first sidewall with a first flange extending therefrom and (ii) a second sidewall with a second flange extending therefrom, where the first and second flanges extend along a first plane and where the first and second sidewalls are substantially opposing and spaced apart to form a cavity;
a first module spacer extending from the purlin above the first plane to facilitate repeatable positioning of a first photovoltaic module on the first flange; and
a second module spacer extending from the purlin above the first plane to facilitate repeatable positioning of the first photovoltaic module on the first flange.

2. The photovoltaic module mounting assembly of claim 1, where the first module spacer is one of brazed or welded to a first interior surface of the first sidewall.

3. The photovoltaic module mounting assembly of claim 1, where the first module spacer is unitary with the purlin.

4. The photovoltaic module mounting assembly of claim 1, where the first and second module spacers are metallic.

5. The photovoltaic module mounting assembly of claim 1, where the first module spacer comprises a first segment that is attached to the first sidewall, a second segment that extends at a first oblique angle from the first segment, and a third segment that extends from the second segment at a second oblique angle, where the second and third segments are in spaced relationship with the purlin.

6. The photovoltaic module mounting assembly of claim 1, where the first module spacer comprises a first segment that is attached to the first sidewall, a second segment that extends at an acute angle from the first segment, and a third segment that extends from the second segment at a second acute angle, where the second and third segments are in spaced relationship with the purlin.

7. The photovoltaic module mounting assembly of claim 1, where the first module spacer comprises a first segment that is attached to the first sidewall and a second segment extending above the first plane.

8. The photovoltaic module mounting assembly of claim 1, where the first module spacer comprises a first segment that extends at an oblique angle from the first sidewall and a second segment substantially coaxial with the first sidewall and extends above the first plane.

9. The photovoltaic module mounting assembly of claim 1, further comprising:
a third module spacer extending from the purlin above the first plane to facilitate repeatable positioning of a second photovoltaic module on the second flange; and
a fourth module spacer extending from the purlin above the first plane to facilitate repeatable positioning of the second photovoltaic module on the second flange,
where the first and second module spacers extend from the first sidewall in spaced relationship on opposite sides of the rotatable torque tube that extends orthogonally to a longitudinal axis of the purlin.

10. The photovoltaic module mounting assembly of claim 1, where the first flange extends orthogonally from the first sidewall.

11. The photovoltaic module mounting assembly of claim 1, further comprising:
a third module spacer attached to the first interior surface of the first sidewall and extending above the first plane; and
a fourth module spacer attached to the second interior surface of the second sidewall and extending above the first plane,
where the first and third module spacers are attached to the first interior surface in spaced relationship on opposite sides of the torque tube that extends orthogonally to a longitudinal axis of the purlin.

12. The photovoltaic module mounting assembly of claim 1, where the first module spacer extends from a first plate located between and attached to the first and second flanges.

13. The photovoltaic module mounting assembly of claim 12, further comprising a second plate located between and attached to the first and second flanges and comprising the second module spacer.

14. The photovoltaic module mounting assembly of claim 1, where the first and second module spacers extend from at least one of a reinforcement channel or a load distribution channel located in the cavity and that the purlin nests around.

15. The photovoltaic module mounting assembly of claim 14, where the third and fourth module spacers extend from at least one of the reinforcement channel or the load distribution channel located in the cavity and that the purlin nests around.

16. The photovoltaic module mounting assembly of claim 8, where the first segment extends at the oblique angle inwardly from the first sidewall.

17. The photovoltaic module mounting assembly of claim 8, where the first segment extends at the oblique angle outwardly from the first sidewall.
